(19) United States
(12) Patent Application Publication
(10) Pub. No.: US 2019/0180285 A1
(43) Pub. Date: Jun. 13, 2019

(54) SYSTEMS AND METHODS FOR FACILITATING SECURE PAYER-AGNOSTIC PAYMENTS

(71) Applicant: Mastercard International Incorporated, Purchase, NY (US)

(72) Inventors: Shreya Mittal, New Delhi (IN); Manish Kumar, Gurgaon (IN); Randhir Kumar, Samastipur (IN)

(73) Assignee: Mastercard International Incorporated, Purchase, NY (US)

(21) Appl. No.: 16/211,685

(22) Filed: Dec. 6, 2018

(30) Foreign Application Priority Data
Dec. 12, 2017 (SG) 10201710339P

(51) Int. Cl. G06Q 20/42; G06Q 20/36; G06Q 20/12

(52) U.S. Cl. CPC G06Q 20/425; G06Q 20/12; G06Q 20/3678; G06Q 20/363

(57) ABSTRACT

The present application provides systems and methods for for facilitating secure payer-agnostic payments. The systems comprise a server for facilitating secure payer-agnostic payments. The server comprises: at least one processor; and at least one memory including computer program code; the at least one memory and the computer program code configured to, with the at least one processor, cause the server at least to: generate a payment request for a purchase transaction made by a first user, the payment request including at least a purchase identifier associated with the purchase transaction and a unique identifier associated with a second user to pay for the purchase transaction, the purchase identifier including at least a payment amount for the purchase transaction; and transmit the payment request to the second user based on the unique identifier associated with the second user.

### CROSS REFERENCE TO RELATED APPLICATIONS

This application claims priority to Singaporean Application Serial No. 10201710339P, filed Dec. 12, 2017, which is incorporated herein by reference in its entirety

### FIELD OF INVENTION

The present disclosure relates broadly, but not exclusively, to systems and methods for facilitating secure payer-agnostic payments.

### BACKGROUND

When a person (for example, person A) shops online, for example, on a merchant's website, another person (for example, person B) may be able to pay for person A's purchase. Such a payment can be referred to as a payer-agnostic payment, since the payer, i.e. person B, is not the purchaser, i.e. person A, who makes the purchase transaction.

Currently, a payer-agnostic payment requires person B to share his private data such as personal and/or financial details with person A. The personal and/or financial details may include person B's payment card number, payment account identifier (for example a username of the payment account), password, Card Verification Value/Card Verification Code (CVV/CVC), second factor authentication information, etc. For example, person B may disclose his personal and/or financial details to person A. Person A may then enter person B's personal and/or financial details on a payment page, either at the merchant's website, or at a payment application portal or an internet banking portal redirected from the merchant's website, to complete payment for the purchase transaction. Alternatively, when person B is around when person A makes the purchase, person B may directly enter his personal and/or financial details on the payment page when it is prompted to person A for the purchase.

In the above scenarios, the payer's, i.e. person B's, personal and/or financial details are shared either at the time of person A using these details to make payment or at the time of person A, as the purchaser, receiving an invoice of payment details after payment is made. Such a sharing of personal and/or financial details causes security concerns in view of increasing digital crimes and internet frauds in this information era.

There is thus a need to provide systems and methods with a secure mechanism that allows payers to pay for payer-agnostic payments without sharing their personal and/or financial details with purchasers, such that secure payer-agnostic payments are facilitated. Furthermore, other desirable features and characteristics will become apparent from the subsequent detailed description and the appended claims, taken in conjunction with the accompanying drawings and this background of the disclosure.

### SUMMARY

According to a first aspect of the present invention, there is provided a server for facilitating secure payer-agnostic payments, the server comprising: at least one processor; and at least one memory including computer program code; the at least one memory and the computer program code configured to, with the at least one processor, cause the server at least to: generate a payment request for a purchase transaction made by a first user, the payment request including at least a purchase identifier associated with the purchase transaction and a unique identifier associated with a second user to pay for the purchase transaction, the purchase identifier including at least a payment amount for the purchase transaction; and transmit the payment request to the second user based on the unique identifier associated with the second user.

According to a second aspect of the present invention, there is provided a digital wallet server for facilitating secure payer-agnostic payments, the digital wallet server comprising: at least one processor; and at least one memory including computer program code; the at least one memory and the computer program code configured to, with the at least one processor, cause the digital wallet server at least to: receive a payment request from a server for a purchase transaction made by a first user, the payment request including at least a purchase identifier associated with the purchase transaction and a unique identifier associated with a second user to pay for the purchase transaction, the purchase identifier including at least a payment amount for the purchase transaction; and send a notification with the payment request to an account that the second user has at the digital wallet server, wherein the unique identifier associated with the second user includes one or more of an email address, a phone number, a username and/or a user number that is associated with the account that the second user has at the digital wallet server.

According to a third aspect of the present invention, there is provided a computer-implemented method for facilitating secure payer-agnostic payments, the method comprising: generating a payment request, by a server, for a purchase transaction made by a first user, the payment request including at least a purchase identifier associated with the purchase transaction and a unique identifier associated with a second user to pay for the purchase transaction, the purchase identifier including at least a payment amount for the purchase transaction; and transmitting, by the server, the payment request to the second user based on the unique identifier associated with the second user.

### BRIEF DESCRIPTION OF THE DRAWINGS

Embodiments of the invention will be better understood and readily apparent to one of ordinary skilled in the art from the following written description, by way of example only, and in conjunction with the drawings, in which:

FIG. 1 shows a flowchart depicting steps of a method for facilitating secure payer-agnostic payments in accordance with certain embodiments;

FIG. 2A shows a schematic of a system 200, in accordance with a first embodiment, having a server for facilitating secure payer-agnostic payments, in which the steps as depicted in FIG. 1 can be implemented;

FIG. 2B shows a schematic of a system 250, in accordance with a second embodiment, having a server for facilitating secure payer-agnostic payments, in which the steps as depicted in FIG. 1 can be implemented;

FIG. 3 shows an exemplary computing device 300 that is configured to realise a server for facilitating secure payer-agnostic payments, including a merchant server 206 or a digital wallet server 208, in accordance with the embodiments shown in FIGS. 2A and 2B; and

FIG. 4 shows a schematic diagram of a server configured to facilitate secure payer-agnostic payments in accordance with certain embodiments. Such a server can be implemented as a merchant server 206 or a digital wallet server 208 as shown in FIGS. 2A and 2B.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “generating”, “transmitting”, “sending”, “completing”, “receiving”, “processing”, “providing”, “authorizing”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be implemented as a server. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The present specification may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

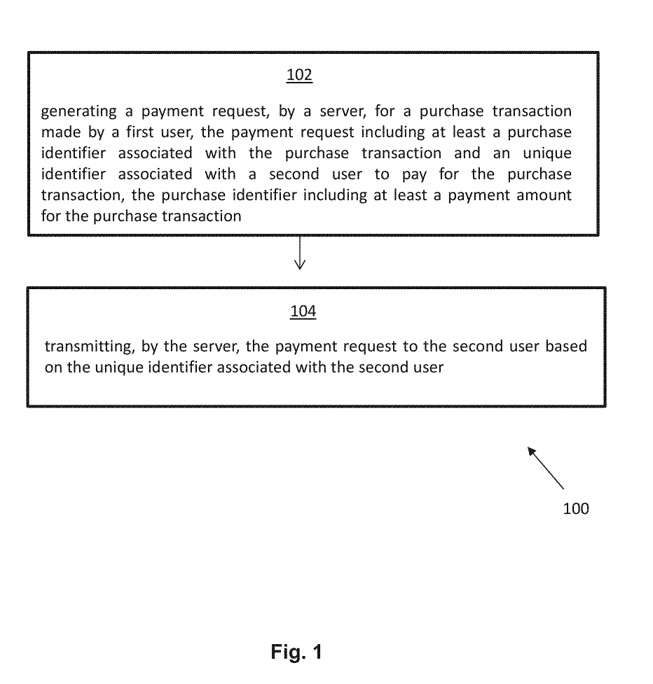

FIG. 1 shows a flowchart illustrating a method 100 for facilitating secure payer-agnostic payments in accordance with embodiments of the invention.

According to various embodiments, the method 100 can be implemented by a server for facilitating secure payer-agnostic payments. In various examples, the server for facilitating secure payer-agnostic payments can be a server that administers an e-commerce website that is accessible through the Internet on an electronic device such as a computer, a mobile phone, a tablet, and the like. The e-commerce website may be an e-commerce platform where various merchants can set up respective online shops to provide various types of goods and/or services to users directly, or an shopping website that carries various brands and collectively provides goods and/or services of these various brands to users, or an online store of a merchant, or any types of website where users can make certain purchase transactions, or the like.

In addition, the server for facilitating secure payer-agnostic payments can also be a server that administers a software application (hereinafter interchangeably referred to as an “App” in the present application) installed and run on an electronic device as mentioned above, for example on an mobile phone, which upon clicking or upon logging in, may allow users to purchase goods and/or services on the App if the electronic device is connected to the Internet.

In view of the above, for the sake of simplicity of the present application, the server for facilitating secure payer-agnostic payments may be interchangeably referred to as a “merchant server”.

The method 100 includes:
Step 102: generating a payment request, by a server, for a purchase transaction made by a first user, the payment request including at least a purchase identifier associated with the purchase transaction and a unique identifier associated with a second user to pay for the purchase transaction, the purchase identifier including at least a payment amount for the purchase transaction.
Step 104: transmitting, by the server, the payment request to the second user based on the unique identifier associated with the second user.

In step 102, a payment request is generated by a server for facilitating secure payer-agnostic payments, for a purchase transaction made by a first user. As described above, according to various embodiments, the payment request can be generated by a server that administers an e-commerce website or an App on which the purchase transaction is made by the first user (which hereinafter may be interchangeably referred to as “User A” in the present application).

According to various embodiment, the payment request can be a message which includes at least a purchase identifier associated with the purchase transaction and a unique identifier associated with a second user (hereinafter interchangeably referred to as “User B” in the present application) to pay for the purchase transaction. The purchase identifier can include at least a payment amount for the purchase transaction.

In some examples, the payment request may further include a merchant identifier, a purchaser identifier associated with the first user, and/or information of purchased items. The purchased items can include goods and/or services that the first user purchased from a merchant's e-commerce website or App. The merchant identifier can include information used to identify accounts of the merchant which are issued by any acquiring party pursuant to rules of certain financial institutes (e.g. Mastercard® International Incorporated rules). The purchaser identifier associated with the first user can include information used to identify the first user. For example, the purchaser identifier can include the first user's name and/or information of the first user's account at the e-commerce website or App which is used to carry out the purchase transaction.

According to various embodiments, the purchase identifier associated with the purchase transaction can be generated by the server, which may include a number of digits and/or letters which identify the purchase transaction and indicate at least a payment amount for the purchase transaction. For example, the purchase identifier may be in the form of “123456_USD120”. The purchase identifier can be created by the server that administers the e-commerce website or the software application on which the purchase transaction is made by the first user.

According to various embodiments, the unique identifier associated with the second user is an identifier of the second user. Advantageously, in the present application, such a unique identifier associated with the second user can be implemented in various ways, according to practical needs of the e-commerce website or App and/or according to feedbacks from customers.

In a first embodiment, the unique identifier associated with the second user can be a reference of the second user that can identify at least an account that the second user has registered with a digital wallet software application or a payment application (which hereinafter may be collectively referred to as a “digital wallet” in the present application). The digital wallet includes Masterpass or any other similar digital wallets or payment applications. Details of the account that the second user has registered with the digital wallet (which may be interchangeably referred to as “account that the second user has at the digital wallet server”) can be stored in a database of a digital wallet server that is configured to administer the digital wallet.

In this embodiment, a digital wallet API can be built in a payment page of the e-commerce website or App. The digital wallet API can be implemented in several ways.

For example, the digital wallet API embedded in the payment page can be implemented by the server that administers the payment page of the e-commerce website or App to allow the first user to enter the unique identifier associated with the second user within the payment page.

Alternatively, due to certain security requirements, the digital wallet API embedded in the payment page may be implemented by the server that administers the e-commerce website or App to re-direct the first user from the payment page to a digital wallet webpage or a digital wallet portal administered by the digital wallet server, such that the unique identifier associated with the second user is firstly provided to the digital wallet server and then distributed to the server that administers the e-commerce website or App for generating the payment request.

According to the first embodiment, the unique identifier associated with the second user includes information that is associated with the account that the second user has at the digital wallet server. The information includes one or more of an email address, a phone number, a username and/or a user number that the digital wallet server may be used to identify the account that the second user has at the digital wallet server (which may be hereinafter interchangeably referred to as a “digital wallet account”). The email address, the phone number, the username and/or the user number may be used by the second user when signing up for the account at the digital wallet server and stored in the database of the digital wallet server as part of the details of this account.

It is appreciable to those skilled in the art that the unique identifier associated with the second user may be identical to an account identifier of the account that the second user has at the digital wallet server.

Alternatively, it is also appreciable to those skilled in the art that the unique identifier in the present application may not necessarily be identical to an account identifier of the account that the second user has at the digital wallet server. While accounts identifiers may have different formats among different digital wallet providers and/or may be internal references used by different digital wallet servers which may contain financial sensitive information, the unique identifier according to the present application uses only general information such as a phone number associated with the second user to identify the second user's digital wallet account which can advantageously reduce the risk of disclosing the second user's financial sensitive information.

In the present embodiment, one or more of funding accounts may be registered under the account that the second user has at the digital wallet server. The one or more of funding accounts may include one or more of a credit account, a debit account, a pre-paid account issued by any issuing party pursuant to rules of certain financial institutions and/or payment schemes (e.g. Mastercard® International Incorporated rules). The registration of the one or more of funding accounts under this account is such that details (for example, funding account number, expiry date, issuer, etc) of the one or more of funding accounts are stored at the database of the digital wallet server, whereby the digital wallet server is able to retrieve the one or more of funding accounts when processing payment(s) using the account. After registration, the one or more of funding accounts are linked to the account that the second user has with the digital wallet server. Upon selection by the second user, it is the selected funding account of the second user that the digital wallet server transmits to a payment network for payment(s) made using the account that the second user has with the digital wallet server. Alternatively, besides the registered the one or more of funding accounts, the second user can enter information of a new funding account that has not been registered to the account that the second user has with the digital wallet server. For the sake of simplicity, the underlying authentication, clearing and settlement programs in the payment network will not be described herein.

In a second embodiment, the unique identifier associated with the second user can be a reference of the second user that can identify at least an account that the second user has registered with the e-commerce website or App on which the purchase transaction is made by the first user. Details of the account that the second user has registered with the e-commerce website or App (which may be interchangeably referred to as “account that the second user has at the server that administers the e-commerce website or App”) can be stored in a database of the server that administers the e-commerce website or App.

In this embodiment, the server that administers the e-commerce website or App is configured to allow the first user to enter the unique identifier associated with the second user within a payment page.

For example, the unique identifier associated with the second user includes information that is associated with the account that the second user has at the server that administers the e-commerce website or App. The information includes one or more of an email address, a phone number, a username and/or a user number that the digital wallet server may be used to identify the account of that the second user has at the server. The email address, the phone number, the username and/or the user number may be used by the second user when signing up for the account at the server and stored in the database of the server as part of the details of this account.

Similar to the unique identifier associated with the second user in the first embodiment, it is appreciable to those skilled in the art that the unique identifier associated with the second user in the second embodiment may also be identical to an account identifier of the account that the second user has at the server that administers the e-commerce website or App on which the purchase transaction is made by the first user.

Alternatively, it is also appreciable to those skilled in the art that the unique identifier associated with the second user in the second embodiment may not necessarily be identical to an account identifier of the account that the second user has at the server that administers the e-commerce website or App on which the purchase transaction is made by the first user. Advantageously, the unique identifier in the second embodiment may also use general information such as a phone number associated with the second user to identify the second user's account at the at the server that administers the e-commerce website or App, which can advantageously reduce the risk of disclosing the second user's private information.

In the above embodiments, step 102 of the method 100 may be implemented after a payer-agnostic payment option is selected by the first user on the payment page. For example, in the purchase transaction, the first user can add goods and/or services (i.e. items) into his/her shopping cart on the e-commerce website or App, and proceed to a payment page of the e-commerce website or App for this purchase transaction. On the payment page, a payer-agnostic payment option can be provided to the first user, whereby the first user can select to request for a payer-agnostic payment either according to the first embodiment or according to the second embodiment as described above.

In step 104, the payment request generated in step 102 can be transmitted by the server to the second user based on the unique identifier associated with the second user. As described above, according to various embodiments, the payment request can be transmitted by the server, that administers the e-commerce website or App on which the purchase transaction is made by the first user, based on the unique identifier associated with the second user.

As described above with respect to step 102, the unique identifier associated with the second user, being an identifier of the second user, can be implemented in various ways according to practical needs of the e-commerce website or App and/or according to feedbacks from customers. For example, the unique identifier associated with the second user can include information associated with the account that the second user has at the digital wallet server, according to the first embodiment described above with respect to step 102, or information associated with the account that the second user has at the server that administers the e-commerce website or App on which the purchase transaction is made by the first user, according to the second embodiment described above with respect to step 102.

In step 104, in scenarios according to the first embodiment, the unique identifier associated with the second user includes information associated with the account that the second user has at the digital wallet server. In these scenarios, the above described digital wallet API embedded in the payment page can be configured to instruct the server that administers the e-commerce website or App to transmit the generated payment request, which includes at least the purchase identifier associated with the purchase transaction and the unique identifier associated with the second user, to the digital wallet server.

Based on the unique identifier associated with the second user, the method 100 can include a further step (not shown in FIG. 1) in which the digital wallet server can be configured to further send a notification with the payment request to the account that the second user has at the digital wallet server.

According to various examples of this further step, the notification with the payment request can be pushed by the digital wallet server as a system message in the digital wallet which can be accessible by an electronic device (such as a computer, a mobile phone, a tablet, and the like) of the second user where the digital wallet is installed. Alternatively, the notification with the payment request can be sent by the digital wallet server as a Short Message Service (SMS) message to a mobile phone of the second user if the number of the mobile phone is linked to the digital wallet for receiving notifications. The sending of the SMS message may be sent by the digital wallet server via traditional SMS services or Internet Protocol-based messaging services. In addition, the notification with the payment request can be sent by the digital wallet server as an email to the second user if an email address of the second user is linked to the digital wallet for receiving notifications.

Advantageously, in the first embodiment, the second user is not necessarily to have any account at the e-commerce website or App for receiving the notification with the payment request. Upon receipt of the notification with the payment request, the second user can log into his/her account at the digital wallet server for making payment or rejecting to making payment.

According to various embodiments, to further facilitating the secure payer-agnostic payments and in view of fluctuating pricings (e.g. air tickets, hotel rates, etc. . . . ) in certain industries, the payment request and/or the notification may be set to be valid for a certain time limit. For example, the time limit can be 3 minutes, 10 minutes, 30 minutes, 24 hours, etc. It is appreciable to the skilled person in the art that the time limit be any time durations according to different practical needs.

In response to the received payment request, the method 100 can include a yet further step (not shown in FIG. 1) in which the second user can authorize the digital wallet server to pay the payment amount indicated in the payment request. At the time of authorizing, in scenarios where one or more of funding accounts have been registered under the second user's account at the digital wallet server, the second user can select at least a funding account among these registered one or more of funding accounts to pay the payment amount indicated in the payment request. Alternatively, at the time of authorizing the digital wallet server to pay the payment amount, the second user can also enter information of a new funding account that has not been registered to the second user's account at the digital wallet server. Upon authorization, the digital wallet server transmits the selected funding account or the newly entered funding account of the second user to a payment network for payment indicated in the payment request. For the sake of simplicity, the underlying authentication, clearing and settlement programs in the payment network will not be described herein.

After the payment of the payment amount using the selected funding account or the newly entered funding account of the second user has been approved through the payment network, the method 100 can include a yet further step (not shown in FIG. 1) in which the payment network can send a confirmation to the digital wallet server to confirm that the payment amount has been paid by the second user.

The digital wallet server can in turn send the confirmation to the server that administers the e-commerce website or App. The digital wallet server may also send the confirmation to the account of the second user. The confirmation may include details of the payment, e.g. payment time, payment method used for this payment (such as, by a credit account, a debit account or a pre-paid account), currency, account name of the second user's digital wallet account, etc. The details of the payment may be used by the merchant who owns or runs the e-commerce website or App to process the payment (for example, to facilitate to identify the payment from a list of incoming payments) and/or implement fraud controls.

In response to receipt of such a confirmation, the method 100 can include a yet further step (not shown in FIG. 1) in which the server that administers the e-commerce website or App can then complete the purchase transaction and inform the first user accordingly. Delivery of the purchased items may be arranged subsequently or concurrently. In some embodiments, the server that administers the e-commerce website or App cam inform the first user by sending a notification to the first user's account at the e-commerce website or App which is used to carry out the purchase transaction. According to various examples, the notification to the first user's account at the e-commerce website or App can be pushed by the server that administers the e-commerce website or App as a system message in the e-commerce website or App which can be accessible by an electronic device (such as a computer, a mobile phone, a tablet, and the like) where the e-commerce website can be visited or where the App is installed. Alternatively, the notification to the first user's account at the e-commerce website or App can be sent by the server that administers the e-commerce website or App as a Short Message Service (SMS) message to a mobile phone of the first user if the number of the mobile phone is linked to the first user's account at the e-commerce website or App for receiving notifications. The sending of the SMS message may be sent by the server that administers the e-commerce website or App via traditional SMS services or Internet Protocol-based messaging services. In addition, the notification to the first user's account at the e-commerce website or App can be sent by the digital wallet server as an email to the first user if an email address of the first user is linked to the first user's account at the e-commerce website or App for receiving notifications.

In step 104, in scenarios according to the second embodiment, the unique identifier associated with the second user includes information associated with the account that the second user has at the server that administers the e-commerce website or App on which the purchase transaction is made by the first user. In these scenarios, the server that administers the e-commerce website or App can transmit the generated payment request, which includes at least the purchase identifier associated with the purchase transaction and the unique identifier associated with the second user, to the second user's account at the e-commerce website or App.

Based on the unique identifier associated with the second user, the server that administers the e-commerce website or App can transmit the payment request to the second user by sending a notification with the payment request to the account that the second user has at the server that administers the e-commerce website or App.

Similar to the notifications described above, according to various examples, the notification to the second user's account at the e-commerce website or App can be pushed by the server that administers the e-commerce website or App as a system message in the e-commerce website or App which can be accessible by an electronic device (such as a computer, a mobile phone, a tablet, and the like) where the e-commerce website can be visited or where the App is installed. Alternatively, the notification to the second user's account at the e-commerce website or App can be sent by the server that administers the e-commerce website or App as a Short Message Service (SMS) message to a mobile phone of the second user if the number of the mobile phone is linked to the second user's account at the e-commerce website or App for receiving notifications. The sending of the SMS message may be sent by the server that administers the e-commerce website or App via traditional SMS services or Internet Protocol-based messaging services. In addition, the notification to the second user's account at the e-commerce website or App can be sent by the digital wallet server as an email to the second user if an email address of the second user is linked to the second user's account at the e-commerce website or App for receiving notifications.

Advantageously, in the second embodiment, the second user is not necessarily to have an account with a digital wallet for using the digital wallet to pay for the payment request. Upon receipt of the notification with the payment request, the second user can log into his/her account at the e-commerce website or App for making payment or rejecting to making payment. Since the second user has an account at the e-commerce website or App, he/she can select any payment method that is acceptable at the e-commerce website or App to pay for the payment request, including any digital wallet and any payment cards.

Similar to the first embodiment, according to various embodiments, to further facilitating the secure payer-agnostic payments and in view of fluctuating pricings (e.g. air tickets, hotel rates, etc. . . . ) in certain industries, the payment request and/or the notification may be set to be valid for a certain time limit. For example, the time limit can be 3 minutes, 10 minutes, 30 minutes, 24 hours, etc. It is appreciable to the skilled person in the art that the time limit can be any time durations according to different practical needs.

In response to the received payment request, the method 100 can include a further step (not shown in FIG. 1) in which the second user can select a payment method to pay for the payment amount indicated in the payment request. In scenarios where a payment method pursuant to rules of certain financial institutions and/or payment schemes (e.g. Mastercard® International Incorporated rules) is selected, the second user may be directed to a payment page administered by an acquiring party of the merchant who owns or runs the e-commerce website or App. Through the payment page, the second user can provide details of at least a funding account to the payment network to pay for the payment amount indicated in the payment request. The funding account can be issued by any issuing party pursuant to rules of the certain financial institutes. For the sake of simplicity, the underlying authentication, clearing and settlement programs in the payment network will not be described herein.

After the payment of the payment amount using the funding account of the second user has been approved through the payment network, the method 100 can include a yet further step (not shown in FIG. 1) in which the payment network can send a confirmation to the merchant server, i.e. the server that administers the commercial website or App, to confirm that the payment of the payment amount has been made by the second user. The confirmation may include details of the payment, e.g. payment time, payment method used for this payment (such as, by a credit account, a debit account or a pre-paid account), currency, account name of the second funding account, etc. The details of the payment may be used by the merchant who owns or runs the e-commerce website or App to process the payment (for example, to facilitate to identify the payment from a list of incoming payments) and/or implement fraud controls.

In response to receipt of such a confirmation from the payment network, the method 100 can include a yet further step (not shown in FIG. 1) in which the server that administers the commercial website or App can complete the purchase transaction and inform the first user accordingly. Delivery of the purchased items may be arranged subsequently or concurrently. In some embodiments, the server that administers the e-commerce website or App cam inform the first user by sending a notification to the first user's account at the e-commerce website or App which is used to carry out the purchase transaction. According to various examples, the notification to the first user's account at the e-commerce website or App can be pushed by the server that administers the e-commerce website or App as a system message in the e-commerce website or App which can be accessible by an electronic device (such as a computer, a mobile phone, a tablet, and the like) where the e-commerce website can be visited or where the App is installed. Alternatively, the notification to the first user's account at the e-commerce website or App can be sent by the server that administers the e-commerce website or App as a Short Message Service (SMS) message to a mobile phone of the first user if the number of the mobile phone is linked to the first user's account at the e-commerce website or App for receiving notifications. The sending of the SMS message may be sent by the server that administers the e-commerce website or App via traditional SMS services or Internet Protocol-based messaging services. In addition, the notification to the first user's account at the e-commerce website or App can be sent by the digital wallet server as an email to the first user if an email address of the first user is linked to the first user's account at the e-commerce website or App for receiving notifications.

In view of the above embodiments, the method 100 that can advantageously facilitate secure payer-agnostic payments is thereby provided.

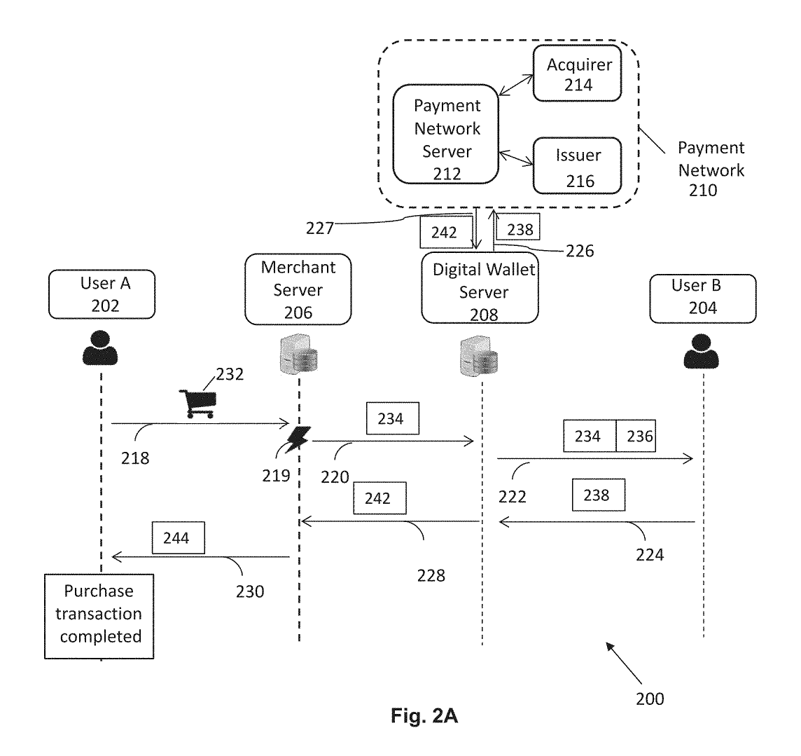

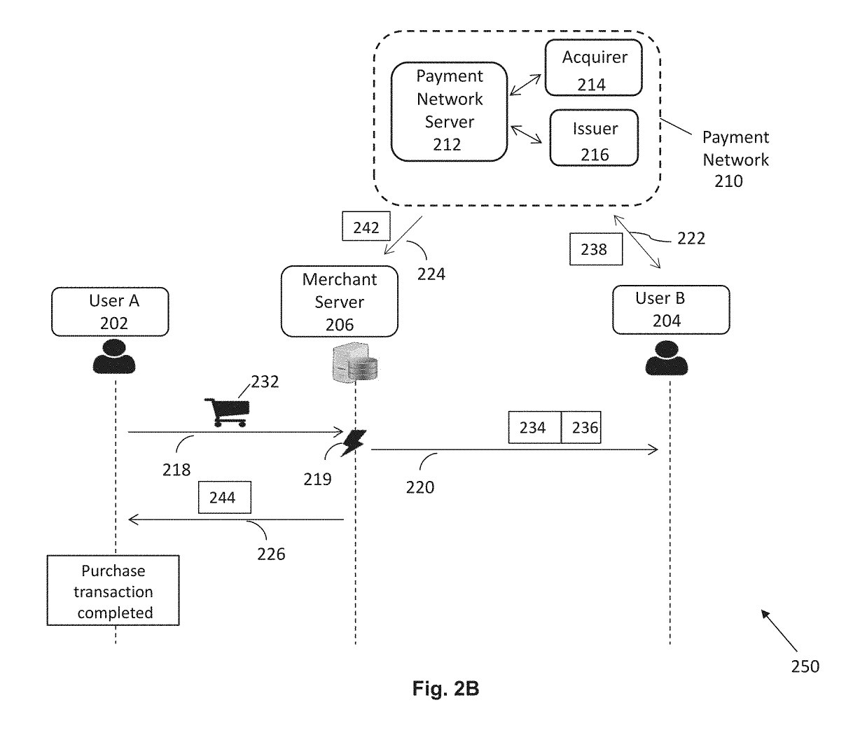

FIG. 2A shows a schematic of a system 200 which includes a first user 202 (i.e. User A), a second user 204 (i.e. User B), a server 206 that administers an e-commerce website or App on which a purchase transaction can be made by the first user 202, and a digital wallet server 208 for the second user to make payment for the purchase transaction. For the sake of simplicity, the server 206 is hereinafter interchangeably referred to as a “merchant server 206”, as mentioned above. According to various embodiments of the present application, the merchant server 206 can be configured to also serve as a server 206 for facilitating secure payer-agnostic payments. In the system 200, the steps as described above with regard to the first embodiment of FIG. 1 can be implemented.

In an exemplified purchase transaction as shown in FIG. 2A, the first user 202 adds goods and/or services (i.e. items) into his/her shopping cart 232 on the e-commerce website or App that is administered by the merchant server 206, and proceeds 218 to a payment page (not illustrated in FIG. 2A) of the e-commerce website or App for the items purchased in the shopping cart 232.

According to various embodiments, a payer-agnostic payment option (not illustrated in FIG. 2A) may be provided on the payment page to the first user 202. By selecting the payer-agnostic payment option, the first user 202 can provide a unique identifier which is associated with second user 204 to appropriate fields of the payment page and indicate that payment of the purchase transaction will be paid by the second user 204. In this manner, the merchant server 206 that communicates with and/or administers the payment page can thereby obtain the unique identifier associated with second user 204, and generate 219 a payment request 234 based on the unique identifier associated with second user 204 and a purchase identifier associated with the purchase transaction. As described above with regard to FIG. 1, the payer-agnostic payment option in the exemplified purchase transaction of FIG. 2 can be realized by embedding a digital wallet API in the e-commerce website or App.

According to various embodiments, the payment request 234 can be a message which includes at least the purchase identifier associated with the purchase transaction and the unique identifier associated with the second user 204 to pay for the purchase transaction. The purchase identifier can include at least a payment amount for the purchase transaction.

According to various embodiments, the purchase identifier associated with the purchase transaction can be created by the merchant server 206. The purchase identifier may include a number of digits and/or letters which identify the purchase transaction and indicate at least a payment amount for the purchase transaction. For example, the purchase identifier may be in the form of “123456_USD120”.

According to various embodiments, the payment request 234 generated by the merchant server 206 may further include a merchant identifier, a purchaser identifier associated with the first user, and/or information of the purchased items (i.e. items in the shopping cart 232). Alternatively, due to certain privacy compliance, information of purchased items may not be included in the payment request 234.

The merchant identifier can include information used to identify accounts of the merchant which are issued by any acquiring party 214 pursuant to rules of certain financial institutions or payment schmemes (e.g. Mastercard® International Incorporated rules). The purchaser identifier associated with the first user 202 can include information used to identify the first user 202 such as the first user's 202 name and/or information of the first user's 202 account at the e-commerce website or App which is used to carry out the exemplified purchase transaction as shown in FIG. 2A.

As described above, as the payment request 234 includes at least the purchase identifier associated with the purchase transaction and the unique identifier associated with the second user 204, the payment request 234 generated by the merchant server 206 can be transmitted to the second user 204 based on the unique identifier associated with the second user 204.

In the exemplified purchase transaction as shown in FIG. 2A, the unique identifier associated with the second user 204 is a reference of the second user 204 that can identify at least an account of the second user 204 which is registered with a digital wallet software application or a payment application (which are collectively referred to as a “digital wallet” in the present application) administered by the digital wallet server 208. The digital wallet includes Masterpass or any other similar digital wallets or payment applications. For the sake of simplicity, the account that the second user 204 has registered with the digital wallet can be interchangeably referred to as “the second user's 204 digital wallet account”. Details of the second user's 204 digital wallet account can be stored in a database of the digital wallet server 208.

In the exemplified purchase transaction as shown in FIG. 2A, the unique identifier associated with the second user 204 includes information that is associated with the second user's 204 digital wallet account at the digital wallet server 208. The information includes one or more of an email address, a phone number, a username and/or a user number that the digital wallet server 208 may be used to identify the second user's 204 digital wallet account. The email address, the phone number, the username and/or the user number may be used by the second user 204 when signing up for the account at the digital wallet server and stored in the database of the digital wallet server 208 as part of the details of the second user's 204 digital wallet account.

As shown in the present embodiment shown in FIG. 2A, the payment request 234 can be transmitted from the merchant server 206 to the second user 204 via the digital wallet server 208. In this embodiment, the merchant server 206 transmits 220 the payment request 234 to the digital wallet server 208, which in turn sends 222 a notification 236 with the payment request 236 to the second user's 204 digital wallet account.

As described above, the sending 222 of the notification 236 with the payment request 236 from the digital wallet server 208 to the second user's 204 digital wallet account can be implemented in various ways. For example, the notification 236 with the payment request 234 can be pushed 222 by the digital wallet server 208 as a system message 236 in the digital wallet which can be accessible by an electronic device (not shown in FIG. 2A, such as a computer, a mobile phone, a tablet, and the like) of the second user 204 where the digital wallet is installed. Alternatively, the notification 236 with the payment request 234 can be sent 222 by the digital wallet server 208 as a Short Message Service (SMS) message to a mobile phone of the second user 204 if the number of the mobile phone is linked to the second user's 204 digital wallet account for receiving notifications. The sending of the SMS message may be sent by the digital wallet server via traditional SMS services or Internet Protocol-based messaging services, and is not illustrated in FIG. 2A. In addition, the notification 236 with the payment request 234 can be sent by the digital wallet server 208 as an email to the second user if an email address of the second user 204 is linked to the digital wallet for receiving notifications.

Advantageously, in the first embodiment, the second user 204 is not necessarily to have any account at the e-commerce website or App for receiving the notification 236 with the payment request 234. Upon receipt of the notification 236 with the payment request 234, the second user 204 can log into his/her digital wallet account for making payment or rejecting to making payment. According to various embodiments, to further facilitate the secure payer-agnostic payments and in view of fluctuating pricings (e.g. air tickets, hotel rates, etc. . . . ) in certain industries, the payment request 234 and/or the notification 236 may be set to be valid for a certain time limit. For example, the time limit can be 3 minutes, 10 minutes, 30 minutes, 24 hours, etc. It is appreciable to the skilled person in the art that the time limit be any time durations according to different practical needs.

In response to the received payment request 234, the second user 204 can authorize 224 the digital wallet server to pay the payment amount indicated in the payment request 234. At the time of authorizing 224, in scenarios where one or more of funding accounts have been registered under the second user's 204 digital wallet account, the second user 204 can select at least a funding account 238 among the registered one or more of funding accounts to pay the payment amount indicated in the payment request 234. Alternatively, at the time of authorizing 224 the digital wallet server 208 to pay the payment amount, the second user 204 can enter information 238 of a new funding account that has not been registered to the second user's 204 digital wallet account. The funding account can be issued to the second user 204 by any issuing party 216 pursuant to rules of the certain financial institutes. Upon authorization 224, the digital wallet server 208 transmits 226 the selected funding account 238 or the newly entered funding account 238 of the second user to a payment network 210 for payment indicated in the payment request 234. The payment network 210 usually comprises a plurality of acquiring party (i.e. acquirer 214), a plurality of issuing party (i.e. issuer 216) and a plurality of payment network server 212, in which authentication, clearing and settlement programs are performed. For the sake of simplicity, the underlying authentication, clearing and settlement programs in the payment network 210 will not be described herein.

After the payment of the payment amount using the selected funding account 238 or the newly entered funding account 238 of the second user 204 has been approved through the payment network 210, the payment network can send 227 a confirmation 242 to the digital wallet server 208 to confirm that the payment amount has been paid by the second user 204.

The digital wallet server 208 can in turn send 228 the confirmation 242 to the merchant server 206. The digital wallet server 208 may also send (not illustrated in FIG. 2A) the confirmation 242 to the account of the second user. The confirmation 242 may include details of the payment, e.g. payment time, payment method used for this payment (such as, by a credit account, a debit account or a pre-paid account), currency, account name of the second user's 204 digital wallet account, etc. The details of the payment may be used by the merchant who owns or runs the e-commerce website or App to process the payment (for example, to facilitate to identify the payment from a list of incoming payments) and/or implement fraud controls.

In response to receipt of such a confirmation 242, the merchant server 206 can then complete 230 the purchase transaction and inform the first user 202 accordingly. Delivery of the purchased items may be arranged subsequently or concurrently. The informing to the first user 202 can be implemented as a message 244 or notification 244 in similar ways as described above with regard to the sending 222 of the notification 236 to the second user 204.

As described above, the present method for facilitating secure payer-agnostic payments can be implemented in the system 200 as illustrated in FIG. 2A.

FIG. 2B shows a schematic of a system 250 which includes a first user 202 (i.e. User A), a second user 204 (i.e. User B), and a server 206 that administers an e-commerce website or App on which a purchase transaction can be made by the first user 202. For the sake of simplicity, the server 206 is hereinafter interchangeably referred to as a “merchant server 206”, as mentioned above. According to various embodiments of the present application, the merchant server 206 can be configured to also serve as a server 206 for facilitating secure payer-agnostic payments. In the system 250, the steps as described above with regard to the second embodiment of FIG. 1 can be implemented.

As shown in FIG. 2B, the first user 202 adds items into his/her shopping cart 232 on the e-commerce website or App that is administered by the merchant server 206, and proceeds 218 to a payment page (not illustrated in FIG. 2B) of the e-commerce website or App for the items purchased in the shopping cart 232.

By selecting the payer-agnostic payment option as described above with regard to FIG. 1 and FIG. 2A, the first user 202 can provide a unique identifier which is associated with the second user 204 to appropriate fields of the payment page and indicate that payment of the purchase transaction will be paid by the second user 204. In this manner, the merchant server 206 that communicates with and/or administers the payment page can thereby obtain the unique identifier associated with second user 204, and generate 219 a payment request 234 based on the unique identifier associated with second user 204 and a purchase identifier associated with the purchase transaction.

In the embodiment shown in FIG. 2B, the unique identifier associated with the second user includes information associated with an account that the second user 204 has at the merchant server 206. This account can be the second user's 204 account at the e-commerce website or App.

According to various embodiments, the payment request 234 can be a message which includes at least the purchase identifier associated with the purchase transaction and the unique identifier associated with the second user 204 to pay for the purchase transaction. The purchase identifier can include at least a payment amount for the purchase transaction.

According to various embodiments, the purchase identifier associated with the purchase transaction can be created by the merchant server 206, as described above.

According to various embodiments, the payment request 234 generated by the merchant server 206 may further include a merchant identifier, a purchaser identifier associated with the first user, and/or information of the purchased items (i.e. items in the shopping cart 232). Alternatively, due to certain privacy compliance, information of purchased items may not be included in the payment request 234. The merchant identifier and the purchaser identifier associated with the first user are similar to those described with regard to FIG. 1 and FIG. 2A.

As described above, as the payment request 234 includes at least the purchase identifier associated with the purchase transaction and the unique identifier associated with the second user 204, the payment request 234 generated by the merchant server 206 can be directly transmitted 220 to the second user 204 based on the unique identifier associated with the second user 204.

The transmission 220 of the payment request 234 to the second user 204 can be implemented in various ways as described above, as a notification 236 with the payment request 234 from the merchant server 206 to the second user's 204 account at the e-commerce website or App.

Advantageously, in the embodiment shown in FIG. 2B, the second user 204 is not necessarily to have an account with a digital wallet to pay for the payment request. Upon receipt of the notification 236 with the payment request 234, the second user 204 can log into his/her account at the e-commerce website or App for making payment or rejecting to making payment. In addition, the second user 204 can select any payment method that is acceptable at the e-commerce website or App to pay for the payment request, including any digital wallet and any payment cards.

In response to the received payment request 234, the second user 204 can select a payment method to pay for the payment amount indicated in the payment request. For example, the second user 204 may select to pay by a funding account issued by any issuing party pursuant to rules of the certain financial institutes. Upon selection of the payment method, the second user 204 may be directed to a payment page administered by an acquiring party of the merchant who owns or runs the e-commerce website or App. Through the payment page, the second user 204 can provide 222 details 238 of at least a funding account to the payment network 210 to pay for the payment amount indicated in the payment request 234. The payment network 210 usually comprises a plurality of acquiring party (i.e. acquirer 214), a plurality of issuing party (i.e. issuer 216) and a plurality of payment network server 212, in which authentication, clearing and settlement programs are performed. For the sake of simplicity, the underlying authentication, clearing and settlement programs in the payment network 210 will not be described herein.

After the payment of the payment amount using the funding account 238 of the second user 204 has been approved through the payment network 210, the payment network 210 can send 224 a confirmation 242 to the merchant wallet server 206 to confirm that the payment amount has been paid by the second user 204. The payment network 210 may also send (not illustrated in FIG. 2B) the confirmation 242 to the funding account of the second user. The confirmation 242 may include details of the payment as described above.

In response to receipt of such a confirmation 242, the merchant server 206 can then complete 226 the purchase transaction and inform the first user 202 accordingly. Delivery of the purchased items may be arranged subsequently or concurrently. The informing to the first user 202 can be implemented as a message 244 or notification 244 in similar ways as described above with regard to the sending 222 of the notification 236 to the second user 204.

As described above, the present method for facilitating secure payer-agnostic payments can be implemented in the system 250 as illustrated in FIG. 2B.

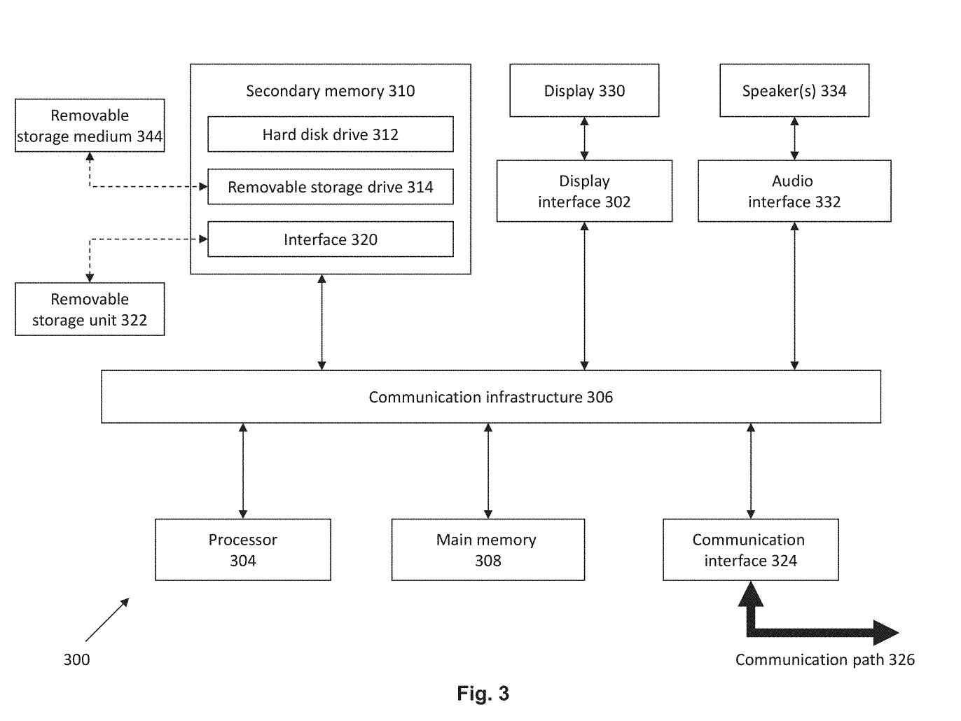

FIG. 3 depicts an exemplary computing device 300, hereinafter interchangeably referred to as a computer system 300, where one or more such computing devices 300 may be used in the above-described system 200, 250 to implement the above-described method 100 for facilitating secure payer-agnostic payments. The exemplary computing device 300 can be used to implement the merchant server 206 to also serve as a server 206 for facilitating secure payer-agnostic payments; or the digital wallet server 208 as described herein.

The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a non-transitory or transitory computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 330. Examples of a removable storage unit 322 and interface 330 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 330 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the inventions, the communication interface 324 permits data to be transferred between the computing device 300 and a data communication network, such as a public data or private data communication network. The communication interface 324 may be used to exchange data between different computing devices 300 which such computing devices 300 form part of an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the storage drive 312, or the interface 350. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example to explain the operation and structure of the merchant server 206 to also serve as a server 206 for facilitating secure payer-agnostic payments; or the digital wallet server 208 as described herein. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

In one embodiment, the computing device 300 is implemented as the server 206 for facilitating secure payer-agnostic payments. The computing device 300 comprises at least one processor and at least one memory including computer program code. The at least one memory and the computer program code are configured to, with the at least one processor, cause the computing device 300 at least to generate a payment request for a purchase transaction made by a first user. The payment request includes at least a purchase identifier associated with the purchase transaction and a unique identifier associated with a second user to pay for the purchase transaction. The purchase identifier includes at least a payment amount for the purchase transaction. Based on the unique identifier associated with the second user, the computing device 300 transmits the payment request to the second user.

In some examples, the payment request further includes a merchant identifier, a purchaser identifier associated with the first user, and/or information of purchased items.

In some examples, when transmitting the payment request to the second user, the computing device 300 is caused to transmit the payment request to a digital wallet server. The digital wallet server is configured to send a notification with the payment request to an account that the second user has at the digital wallet server. In these examples, the unique identifier associated with the second user includes one or more of an email address, a phone number, a username and/or a user number that is associated with the account that the second user has at the digital wallet server. In these examples, the computing device 300 is further caused to complete the purchase transaction in response to receipt, from the digital wallet server, of a confirmation that the payment amount indicated in the payment request has been paid by the second user.

In some examples, when transmitting the payment request to the second user, the computing device 300 is caused to send a notification with the payment request to an account that the second user has at the computing device 300. In these examples, the unique identifier associated with the second user includes one or more of an email address, a phone number, a username and/or a user number that is associated with the account that the second user has at the computing device 300. In these examples, the computing device 300 is further caused to complete the purchase transaction by the computing device 300 in response to receipt of a confirmation from a payment network that the payment amount indicated in the payment request has been paid by the second user.

In another embodiment, the computing device 300 is implemented as the digital wallet server 208 for facilitating secure payer-agnostic payments. The computing device 300 comprises at least one processor; and at least one memory including computer program code. The at least one memory and the computer program code are configured to, with the at least one processor, cause the computing device 300 at least to receive a payment request from a server for a purchase transaction made by a first user. The payment request includes at least a purchase identifier associated with the purchase transaction and a unique identifier associated with a second user to pay for the purchase transaction. The purchase identifier includes at least a payment amount for the purchase transaction. With the payment request, the computing device 300 sends a notification to an account that the second user has at the computing device 300. The unique identifier associated with the second user includes one or more of an email address, a phone number, a username and/or a user number that is associated with the account that the second user has at the computing device 300.

In some examples, the computing device 300 is further caused to receive an authorization from the second user to pay the payment amount indicated in the payment request using at least a funding account registered under the account that the second user has at the computing device 300, and process the payment request using details of the funding account through a payment network that the funding account belongs to. In these embodiments, the details of the funding account are provided by the second user along with the authorization. Alternatively, in these embodiments, the details of the funding account are stored in a database of the computing device 300. The details of the funding account are associated with the account that the second user has at the computing device 300. In these examples, the computing device 300 is further caused to send a confirmation to the server after the payment amount is paid.

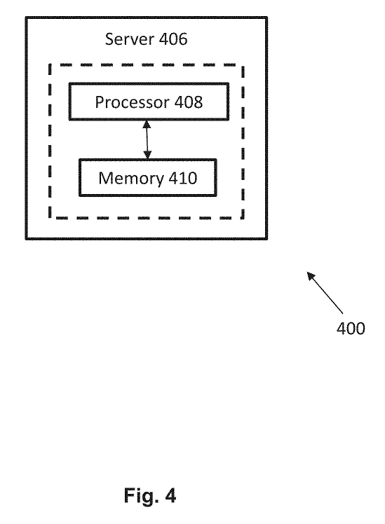

FIG. 4 shows a schematic diagram 400 of a server 406 configured to facilitate secure payer-agnostic payments in accordance with the embodiments of the invention. As described above, the server 406 can be implemented as the merchant server 206 to facilitate secure payer-agnostic payment. Alternatively, the server 406 may be implemented as the digital wallet server 208. The server 406 comprises at least one processor 408 and at least one memory 410 including computer program code (not shown). The at least one memory 410 and the computer program code configured to, with the at least one processor 408, cause the server 406 at least to perform the steps as described with regard to FIG. 1.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects illustrative and not restrictive.

1. A server for facilitating secure payer-agnostic payments, the server comprising:
at least one processor; and
at least one memory including computer program code;
the at least one memory and the computer program code configured to, with the at least one processor, cause the server at least to:
generate a payment request for a purchase transaction made by a first user, the payment request including at least a purchase identifier associated with the purchase transaction and a unique identifier associated with a second user to pay for the purchase transaction, the purchase identifier including at least a payment amount for the purchase transaction; and
transmit the payment request to the second user based on the unique identifier associated with the second user.

2. The server according to claim 1,
wherein the payment request further includes a merchant identifier, a purchaser identifier associated with the first user, and/or information of purchased items.

3. The server according to claim 1,
wherein at the step of transmitting the payment request to the second user, the server is caused to transmit the payment request to a digital wallet server, wherein the digital wallet server is configured to send a notification with the payment request to an account that the second user has at the digital wallet server.

4. The server according to claim 3,
wherein the unique identifier associated with the second user includes one or more of an email address, a phone number, a username and/or a user number that is associated with the account that the second user has at the digital wallet server.

5. The server according to claim 3,
wherein the server is further caused to:
completing the purchase transaction in response to receipt, from the digital wallet server, of a confirmation that the payment amount indicated in the payment request has been paid by the second user.

6. The server according to claim 1,
wherein at the step of transmitting the payment request to the second user, the server is caused to send a notification with the payment request to an account that the second user has at the server.

7. The server according to claim 6,
wherein the unique identifier associated with the second user includes one or more of an email address, a phone number, a username and/or a user number that is associated with the account that the second user has at the server.

8. The server according to claim 6,
wherein the server is further caused to:
completing the purchase transaction by the server in response to receipt of a confirmation from a payment network that the payment amount indicated in the payment request has been paid by the second user.

9. A digital wallet server for facilitating secure payer-agnostic payments, the digital wallet server comprising:
at least one processor; and
at least one memory including computer program code;
the at least one memory and the computer program code configured to, with the at least one processor, cause the digital wallet server at least to:
receive a payment request from a server for a purchase transaction made by a first user, the payment request including at least a purchase identifier associated with the purchase transaction and a unique identifier associated with a second user to pay for the purchase transaction, the purchase identifier including at least a payment amount for the purchase transaction; and
send a notification with the payment request to an account that the second user has at the digital wallet server,
wherein the unique identifier associated with the second user includes one or more of an email address, a phone number, a username and/or a user number that is associated with the account that the second user has at the digital wallet server.

10. The digital wallet server according to claim 9, wherein the digital wallet server is further caused to:
receive an authorization from the second user to pay the payment amount indicated in the payment request using at least a funding account registered under the account that the second user has at the digital wallet server, and
process the payment request using details of the funding account through a payment network that the funding account belongs to.

11. The digital wallet server according to claim 10, wherein the details of the funding account are provided by the second user along with the authorization.

12. The digital wallet server according to claim 10, wherein the details of the funding account are stored in a database of the digital wallet server, the details of the funding account being associated with the account that the second user has at the digital wallet server.

13. The digital wallet server according to claim 12 is further caused to:
send a confirmation to the server after the payment amount is paid.

14. A computer-implemented method for facilitating secure payer-agnostic payments, the method comprising:
generating a payment request, by a server, for a purchase transaction made by a first user, the payment request including at least a purchase identifier associated with the purchase transaction and a unique identifier associated with a second user to pay for the purchase transaction, the purchase identifier including at least a payment amount for the purchase transaction; and
transmitting, by the server, the payment request to the second user based on the unique identifier associated with the second user.

15. The computer-implemented method according to claim 14,
wherein the payment request further includes a merchant identifier, a purchaser identifier associated with the first user, and/or information of purchased items.

16. The computer-implemented method according to claim 14, wherein the step of transmitting the payment request to the second user comprises:
transmitting, by the server, the payment request to a digital wallet server, wherein the digital wallet server is configured to send a notification with the payment request to an account that the second user has at the digital wallet server.

17. The computer-implemented method according to claim 16,
wherein the unique identifier associated with the second user includes one or more of an email address, a phone number, a username and/or a user number that is associated with the account that the second user has at the digital wallet server.

18. The computer-implemented method according to claim 16, further comprising:
in response to the payment request, authorizing the digital wallet server, by the second user, to pay the payment amount indicated in the payment request using at least a funding account registered under the account that the second user has at the digital wallet server.

19. The computer-implemented method according to claim 16, further comprising:
completing the purchase transaction by the server in response to receipt of a confirmation from the digital wallet server that the payment amount has been paid by the second user.

20. The computer-implemented method according to claim 14, wherein the step of transmitting the payment request to the second user comprises:
sending, by the server, a notification with the payment request to an account that the second user has at the server.
